(19) United States
(12) Patent Application Publication
(10) Pub. No.: US 2010/0293001 A1
(43) Pub. Date: Nov. 18, 2010

(54) Method and System to Create a National Health Information Infrastructure

(75) Inventor: Robert Daniel Claud, III, Chicago, IL (US)

Correspondence Address: BANNER & WITCOFF, LTD., TEN SOUTH WACKER DRIVE, SUITE 3000, CHICAGO, IL, 60606, US

(73) Assignee: eCapable, Inc., Chicago, IL (US)

(21) Appl. No.: 12/633,560

(22) Filed: Dec. 8, 2009

Related U.S. Application Data
(63) Continuation of application No. 11/361,764, filed on Feb. 24, 2006, now abandoned.
Application No. 11/361,764 is a continuation-in-part of application No. 11/089,400, filed on Mar. 24, 2005, now abandoned.
Application No. 11/089,400 is a continuation of application No. 11/669,635, filed on Jan. 31, 2007.
Application No. 11/669,635 is a continuation-in-part of application No. 11/089,400, filed on Mar. 24, 2005, now abandoned.
Application No. 11/089,400 is a continuation of application No. 12/245,419, filed on Oct. 3, 2008, now abandoned.
Application No. 12/245,419 is a continuation-in-part of application No. 11/361,764, filed on Feb. 24, 2006, now abandoned.
Application No. 11/361,764 is a continuation-in-part of application No. 11/669,635, filed on Jan. 31, 2007.
Application No. 11/669,635 is a continuation-in-part of application No. 11/089,400, filed on Mar. 24, 2005, now abandoned.
(60) Provisional application No. 60/656,609, filed on Feb. 26, 2005.
(60) Provisional application No. 60/681,423, filed on May 16, 2005.
(60) Provisional application No. 60/716,385, filed on Sep. 13, 2005.
(60) Provisional application No. 60/556,470, filed on Mar. 26, 2004.
(60) Provisional application No. 60/577,855, filed on Jun. 8, 2004.
(60) Provisional application No. 60/578,189, filed on Jun. 9, 2004.
(60) Provisional application No. 60/598,470, filed on Aug. 3, 2004.
(60) Provisional application No. 60/609,973, filed on Sep. 15, 2004.
(60) Provisional application No. 60/624,516, filed on Nov. 3, 2004.
(60) Provisional application No. 60/845,859, filed on Sep. 20, 2006.
(60) Provisional application No. 60/842,716, filed on Sep. 7, 2006.
(60) Provisional application No. 60/811,500, filed on Jun. 7, 2006.
(60) Provisional application No. 60/808,662, filed on May 26, 2006.
(60) Provisional application No. 60/799,836, filed on May 12, 2006.
(60) Provisional application No. 60/764,746, filed on Feb. 3, 2006.
(60) Provisional application No. 60/763,727, filed on Feb. 1, 2006.
(60) Provisional application No. 60/997,467, filed on Oct. 3, 2007.

(51) Int. Cl. G06Q 50/00; G06Q 30/00

(52) U.S. Cl. 705/2

(57) ABSTRACT

A medication list management and electronic prescribing system incorporates a method of generating tamper-evident prescriptions on paper. Using password protected web pages, health care workers or patients can cause the transmission of machine-readable protected health information from the inventive system to another information management system using the tamper-evident prescriptions described. Non-participants can verify the authenticity of printed protected health information but are not able to create the automated transmission of this information from the inventive system to another information management system. This transmission of machine-readable protected health information has an economic value that is sufficient to be used as an inducement to health care providers across the industry to use a common information technology platform to accomplish such tasks.

### CROSS REFERENCE TO RELATED APPLICATIONS

This application is a continuation of the following applications which are incorporated herein by reference and for which priority is claimed: Ser. No. 12/245,419 filed Oct. 30, 2008 entitled “Improved Method and System to Create a National Health Information Infrastructure”; Ser. No. 61/135,564 filed Jul. 22, 2008 entitled “______”; Ser. No. 11/669,635 filed Jan. 31, 2007 entitled “Method which Creates a Community-Wide Health Information Infrastructure”; Ser. No. 11/361,764 filed Feb. 24, 2006 entitled “Method and System to Facilitate Decision Point Information Flow and to Improve Compliance With a Given Standardized Vocabulary”; Ser. No. 11/089,400 filed Mar. 24, 2005 entitled “Method, Device and Systems to Facilitate Identity Management and Bidirectional Data Flow Within a Patient Electronic Record Keeping System”; provisional application Ser. No. 60/997,467 filed Oct. 3, 2007 entitled “Improved Method and System to Create a National Health Information Infrastructure”; Ser. No. 60/624,516 filed Nov. 3, 2004 entitled “Method, Device, and System to Facilitate Identity Management and Bidirectional Data Flow Within a Healthcare Environment”; Ser. No. 60/609,973 filed Sep. 15, 2004 entitled “Methods and System for ‘One Click Check In’ with a Health Care Provider That Allows Bi-directional Information Flow at Time of Check In”; Ser. No. 60/598,470 filed Aug. 3, 2004 entitled “Method and System for Creating a Personal Digital Key with Ubiquitous Convenient Access Characteristics”; Ser. No. 60/577,855 filed Jun. 8, 2004 entitled “Methods and System for Identity Verification and Access Control”; and Ser. No. 60/556,470 filed Mar. 26, 2004 entitled “Methods and System for Health Care Consumer Empowerment Through Medical Records Storage and Retrieval” all of which priority is claimed.

### BACKGROUND OF THE INVENTION

In 2006, 3.3 billion prescriptions were filled in the United States. Spending in the U.S. for prescription drugs was $192,041,120,674 in 2006. Any process improvement that results in increased efficiency in the prescription drug fulfillment process is likely to result in net savings for the public.

Privacy concerns affect the free flow of information in the health care industry. Patients, health care providers, and vendors working in the industry are all generally expected to limit access to protected health information to those with a need to know it. Such concerns also involve information regarding prescription drug use.

Thus, medication management associated with health care today has multiple problematic aspects. Among these are:

1) Currently there are at least three sources of varying reliability and agreement, for medication lists:

a) the patient;

b) the prescriptions various providers write; and

c) the medication history (generally based on claims data).

2) Currently, health care providers prefer to use a paper form to write prescriptions, such that electronic prescribing solutions compete, chiefly, with paper prescription pads which are readily available and quick.

3) Health care providers generally embrace change reluctantly, one reason that e-prescribing has not been widely adopted.

4) The Joint Commission, a national accreditation body, has embraced medication reconciliation across the continuum of care—effectively, sharing of the patient's medication list by all health care providers who participate in a unique patient's care—as a worthwhile safety initiative by all health care providers.

Thus, accommodating these factors has presented a significant public challenge.

### SUMMARY OF THE INVENTION

A medication list management and electronic prescribing system is described which incorporates a method of generating tamper-evident prescriptions on ordinary paper. This system is used to create a common electronic platform, or Network, by which health care industry workers may securely transfer machine-readable protected health information from one information management system to another. Members of the Network, using password protected web-pages, can cause the transmission of machine-readable protected health information from the inventive system to another information management system using the methods described. Non-members of the Network can verify the authenticity of printed protected health information but are not able to create the automated transmission of this information from the system to another information management system. The availability of machine-readable protected health information that moves with the patient throughout the health care system has an economic value that is sufficient to be used as an inducement to health care providers across the industry to use a common information technology platform (the Network) to accomplish such tasks.

In a principal aspect, the present invention relates to the field of medicine, specifically, the creation of a Network of diverse health care providers, patients, and pharmacists, who may have no pre-existing relationship with each other, but who are working together to exchange information via the common platform described to create a secure exchange of prescription information between prescribing practitioner and pharmacist:

1) In a manner controlled by the patient;

2) In a manner which allows the prescribing practitioner to ignore which pharmacist will receive the information;

3) In a manner which allows the prescribing practitioner to generate a paper prescription information for the patient,

4) In a manner which allows the pharmacist who receives the prescription and participates in a Network to electronically import the prescription information (e.g. patient name, prescriber name, drug, dose, etc.) into an information system used by the pharmacist; and

5) In a manner such that pharmacists who have not previously elected to participate in the Network may nonetheless verify that the information printed on a prescription paper has not been altered.

In an aspect of the current invention the automated transfer of prescription information from one computer system to another is used as an inducement to a pharmacy, pharmacist, or chain of pharmacies to participate in a Network of diverse health care providers, patients, and pharmacists who are collectively working together to exchange data.

In an aspect of the invention the automated transfer of prescription information from the appropriately programmed computer system to another is used as an inducement to a pharmacy, pharmacist, or chain of pharmacies to pay membership fees to participate in a Network of diverse health care providers, patients, and pharmacists who are collectively working together to exchange data.

In an aspect of the invention, automated transfer of prescription information from the programmed computer system to another is used as an inducement to a pharmacy, pharmacist, or chain of pharmacies to purchase and/or distribute membership accounts to patients allowing them to participate in a Network of diverse health care providers, patients, and pharmacists who are collectively working together to exchange data.

In an aspect of the invention the automated transfer of prescription information from the programmed computer system to another system is used as an inducement to a pharmacy, pharmacist, or chain of pharmacies to purchase and/or distribute membership accounts to prescribing practitioners or other health care providers or health care institutions allowing them to participate in a Network of diverse health care providers, patients, and pharmacists who are collectively working together to exchange data.

In an aspect of the invention the automated transfer of prescription information from the programmed computer system to another system or computer is used as an inducement to a prescribing practitioner, health care provider or health care institution to purchase and/or distribute membership accounts to patients allowing them to participate in a Network of diverse health care providers, patients, and pharmacists who are collectively working together to exchange data.

In an aspect of the invention the automated transfer of prescription information from the programmed computer system to another system or computer is used as an inducement to a prescribing practitioner, health care provider or health care institution to participate in a Network of diverse health care providers, patients, and pharmacists who are collectively working together to exchange data.

In an aspect of the invention the automated transfer of prescription information from the programmed computer system to another system or computer is used as an inducement to a prescribing practitioner, health care provider or health care institution to pay membership fees to participate in a Network of diverse health care providers, patients, and pharmacists who are collectively working together to exchange data.

In an aspect of the invention the automated transfer of prescription information from the programmed computer system to another system or computer is used as an inducement to a prescribing practitioner, health care provider or health care institution to purchase and/or distribute membership accounts to patients allowing them to participate in a Network of diverse health care providers, patients, and pharmacists who are collectively working together to exchange data.

In an aspect of the invention the automated transfer of prescription information from the programmed computer system to another system or computer is used as an inducement to a prescribing practitioner, health care provider or health care institution to purchase and/or distribute membership accounts to prescribing practitioners or other health care providers or health care institutions allowing them to participate in a Network of diverse health care providers, patients, and pharmacists who are collectively working together to exchange data.

In an aspect of the invention the automated transfer, or availability, of protected health information other than prescription information from the system is used as an inducement to a pharmacy, pharmacist, or chain of pharmacies to participate in a Network of diverse health care providers, patients, and pharmacists who are collectively working together to exchange data.

In an aspect of the invention the automated transfer, or availability, of protected health information other than prescription information from the system is used as an inducement to a pharmacy, pharmacist, or chain of pharmacies to pay membership fees to participate in a Network of diverse health care providers, patients, and pharmacists who are collectively working together to exchange data.

In an aspect of the invention the automated transfer, or availability, of protected health information other than prescription information from the system is used as an inducement to a pharmacy, pharmacist, or chain of pharmacies to purchase and/or distribute membership accounts to patients allowing them to participate in a Network of diverse health care providers, patients, and pharmacists who are collectively working together to exchange data.

In an aspect of the invention the automated transfer, or availability, of protected health information other than prescription information from the system is used as an inducement to a pharmacy, pharmacist, or chain of pharmacies to purchase and/or distribute membership accounts to prescribing practitioners or other health care providers or health care institutions allowing them to participate in a Network of diverse health care providers, patients, and pharmacists who are collectively working together to exchange data.

In an aspect of the invention the automated transfer, or availability, of protected health information other than prescription information from the system is used as an inducement to a prescribing practitioner, health care provider or health care institution to purchase and/or distribute membership accounts to patients allowing them to participate in a Network of diverse health care providers, patients, and pharmacists who are collectively working together to exchange data.

In an aspect of the invention the automated transfer, or availability, of protected health information other than prescription information from the system is used as an inducement to a prescribing practitioner, health care provider or health care institution to participate in a Network of diverse health care providers, patients, and pharmacists who are collectively working together to exchange data.

In an aspect of the invention the automated transfer, or availability, of protected health information other than prescription information from the system is used as an inducement to a prescribing practitioner, health care provider or health care institution to pay membership fees to participate in a Network of diverse health care providers, patients, and pharmacists who are collectively working together to exchange data.

In an aspect of the invention the automated transfer, or availability, of protected health information other than prescription information from the system is used as an inducement to a prescribing practitioner, health care provider or health care institution to purchase and/or distribute membership accounts to patients allowing them to participate in a Network of diverse health care providers, patients, and pharmacists who are collectively working together to exchange data.

In an aspect of the invention the automated transfer, or availability, of protected health information other than prescription information from the system is used as an inducement to a prescribing practitioner, health care provider or health care institution to purchase and/or distribute membership accounts to prescribing practitioners or other health care providers or health care institutions allowing them to participate in a Network of diverse health care providers, patients, and pharmacists who are collectively working together to exchange data.

### BRIEF DESCRIPTION OF THE DRAWING

In the detailed description which follows, reference will be made to the drawing comprised of the following Figures:

FIG. 1 is a flow chart indicating the methodology and system of the invention;

FIG. 2 is a further flow chart indicating the methodology and system of the invention;

FIG. 3 is an additional flow chart depicting the method and system of the invention;

FIG. 4 is a typical prescription form utilized in the practice of the method and system of the invention;

FIG. 5 is a typical warning label that would be included as a part of the practice of the method and system of the invention;

FIG. 6 is a further flow diagram depicting the method and system of the invention as involving a pharmacist;

FIG. 7 is a screen shot depicting a feature of the method and system of the invention;

FIG. 8 is a further screen shot illustrating the method and system of the practice of the invention;

FIG. 9 is a further screen shot illustrating the system and methodology of the practice of the invention; and

FIG. 10 is a table illustrating the database of stored material on a central server as incorporated with an embodiment of the invention.

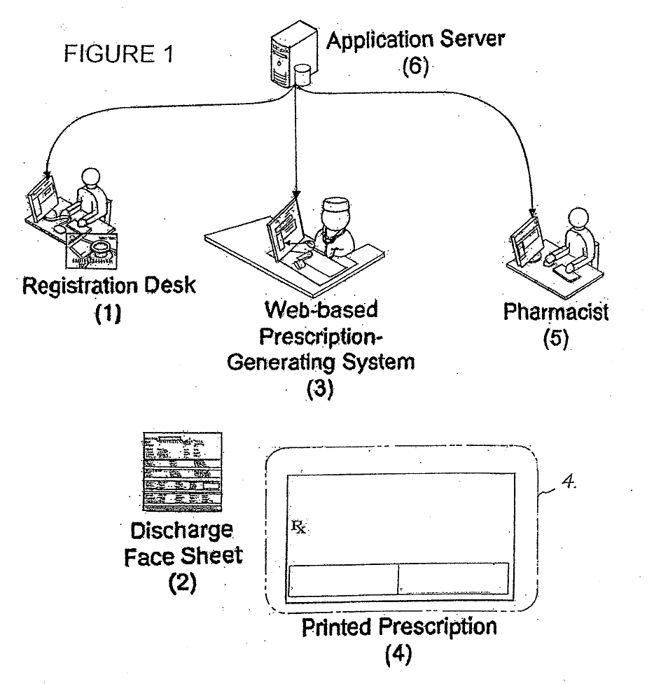

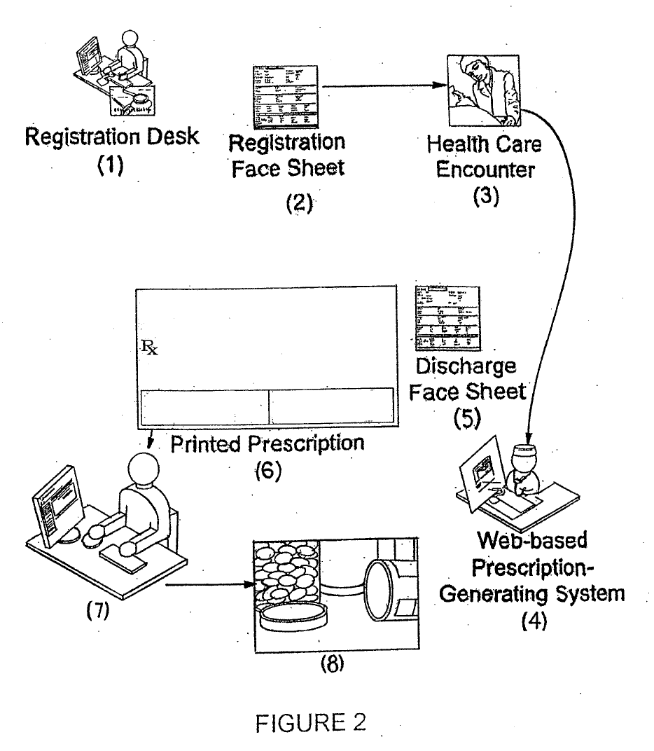

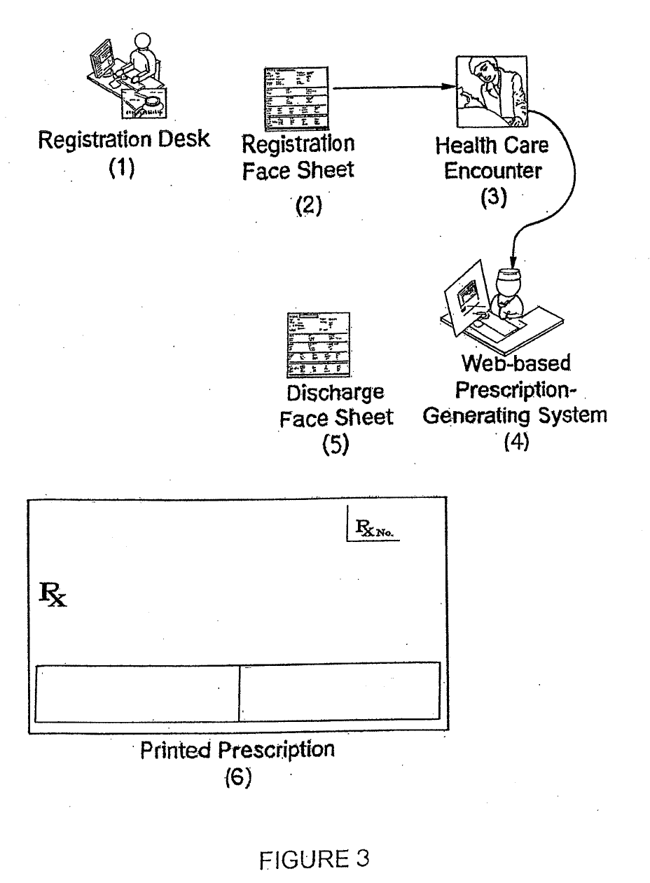

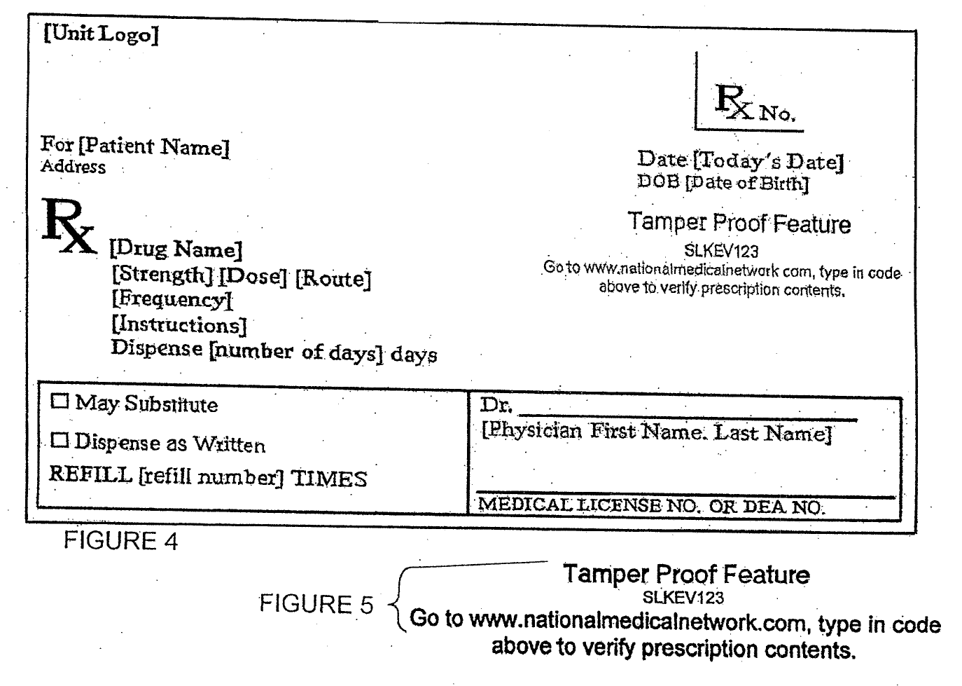

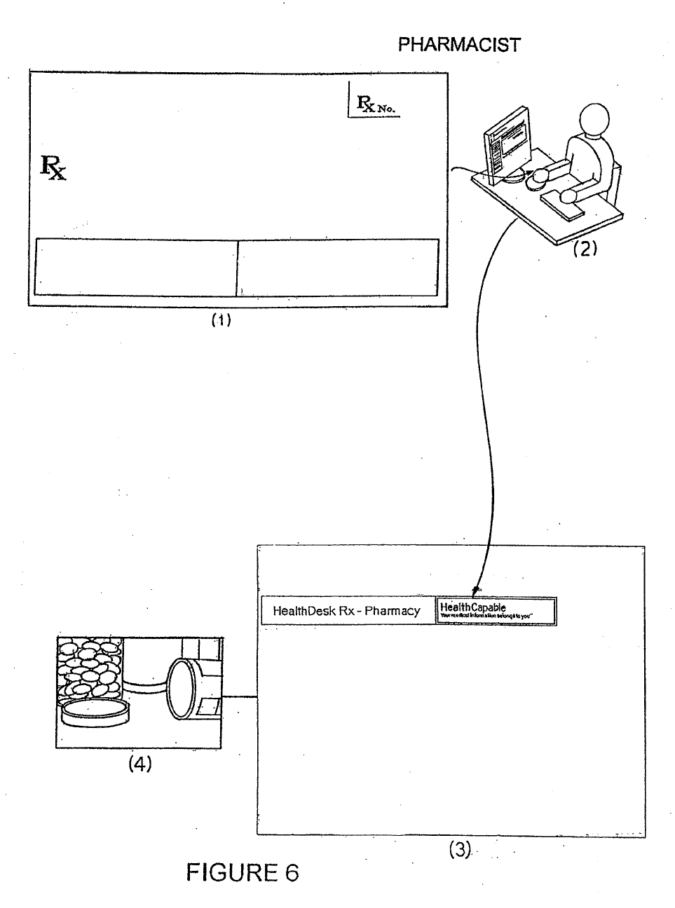

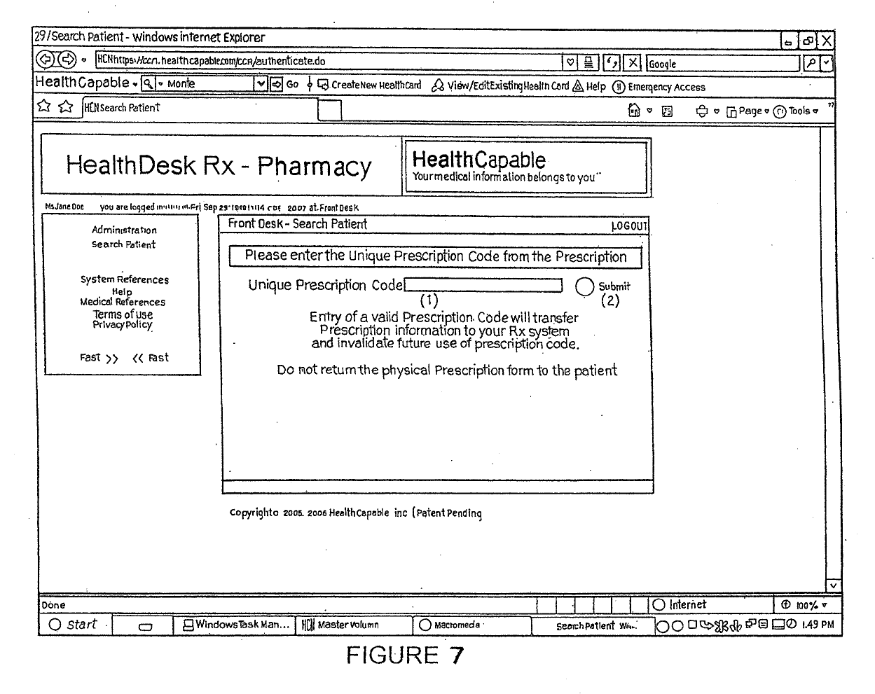

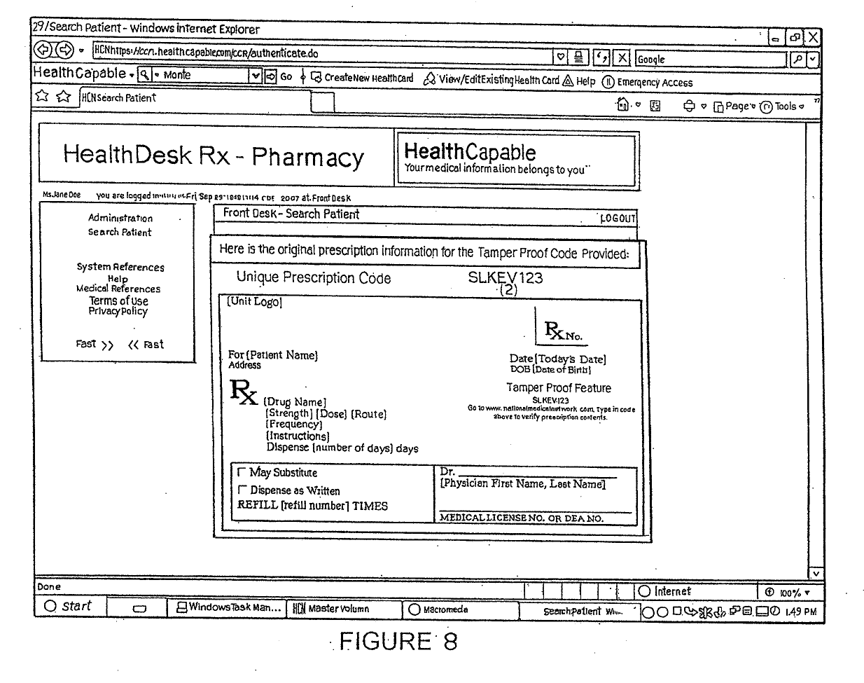

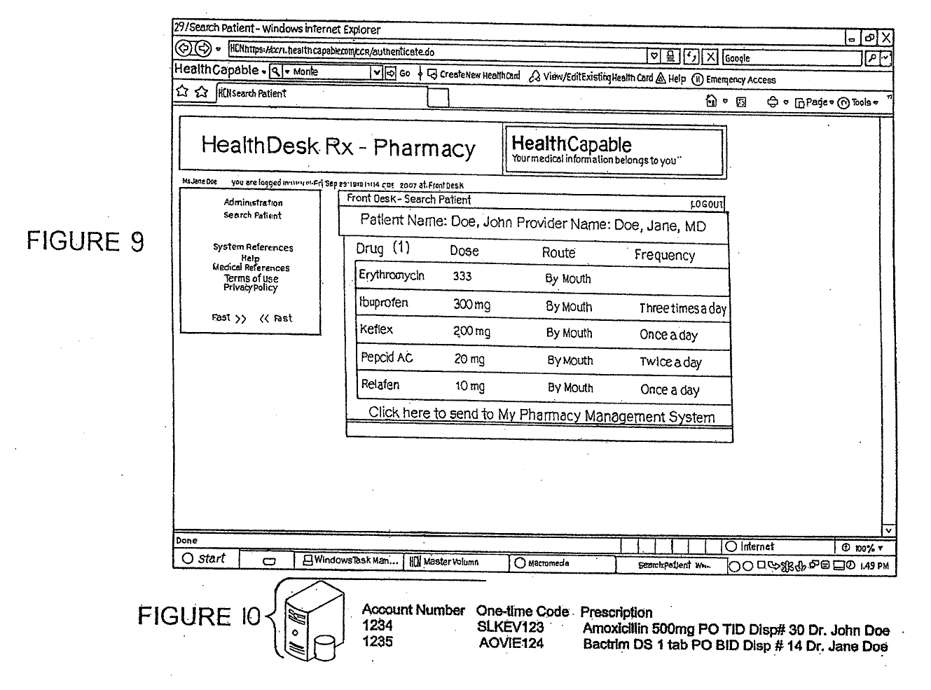

### DESCRIPTION OF EMBODIMENTS OF THE INVENTION

In the following description, various terms will be utilized in their normal sense and context and will include the following additional features with respect thereto:

“User” will mean an individual who desires to have access to the data contained in a database, whether to view it only or to view and change it.

“Screen” means the visual presentation at a terminal setting forth and representing information visually to the user. The screen may include tool bars and other information, instructions, and the like which will facilitate use of the information provided to or by the user as well as interactions by or for the user through the terminal to a server.

“Unique identifying number” means a character sequence which has been uniquely assigned to a specific user—utilizing an association assigned by the system upon first use of the system by that user.

“One-time Code” will mean a unique character sequence which has been generated using a random-number generator (which also confirms that the sequence has not been previously used), then assigned a relationship with another defined set of information contained in a database.

“Client” means a user's computer, as distinguished from a central server to which it may be connected over a network.

“Central Server” means a computer which is connected to a network, and which is used as a central repository for the storage and retrieval of electronic information. A central server also runs applications, generally written in machine-interpretable code, which define the ways the central server will interact with information submitted to it over a network.

“network” (where not capitalized) means any means of electronic data transfer communication between servers, terminals and hardware including the World Wide Web, wireless and wired internal dedicated networks and external networks.

“Network” (where capitalized) refers to the group of diverse health care providers, patients, and pharmacists who collectively have agreed to use a common information exchange platform (e.g. according to the current invention herein described) to accomplish the secured exchange of protected health information between themselves.

“Password” means a character sequence which is meant to be known to a specific user and generally not known by others.

“Text Entry Interface” is used to represent an area of a computer user interface that is used to display characters typed by the user; in our current preferred embodiment this is in the context of a browser window on a client computer.

The system generally includes discrete physical elements, associated with a network which connects the necessary computers/servers.

1) client computers;

2) a central server (computer);

3) a network that connects the two;

4) a printer;

5) a prescription form that is the tangible output of a printer working in combination with a client computer using the inventive system; and

6) a Network, comprising diverse health care providers, patients, and pharmacists, who may have no pre-existing relationship with each other, but who are working together to exchange information via the common platform described here.

The system employs the principle of an account, sometimes called a primary key in a database, that is used to identify users. Each account is assigned a role that functionally reflects the role that the account holder is expected to play in the health care industry. The role assigned to the account defines the privileges assigned to the account; from a practical standpoint, the role assigned to the account may define what web pages the account is allowed to view.

According to one embodiment of the invention, several roles are described:

1) “Patient,” which refers to a health care consumer who is an account holder in the inventive system.

2) “HealthDesk,” which refers to the initial registration process of a health care provider who is a Network member.

3) “HealthDesk Rx” which refers to the process by which an HCN-member health care provider may update a Patient's medication list including prescribing additional medications.

4) “Pharmacist” which refers to the process that occurs when a patient presents a prescription generated by the inventive system to an HCN-member Pharmacist using the inventive system.

5) “RxCheck” which refers to the process that occurs when a pharmacist who is not a member of the Network desires to verify the authenticity of a prescription; this process does not allow for the automated transfer of prescription information from the inventive system to a pharmacist's information management system.

According to one sequence illustrating an embodiment of the invention:

1) Patient presents his account number to the registration clerk at the front desk of a Network-member health care provider's office.

2) Using the web pages associated with the HealthDesk role, working on a client computer, the clerk submits the patient's account number to the central server.

3) The central server returns information called the “Face Sheet” to the clerk's client computer that includes, at a minimum, the medication list associated with the account number submitted to the central server.

4) A health care provider encounter occurs.

5) Using web pages associated with the HealthDesk Rx role, the health care provider can reference the information shown on the Face Sheet when prescribing new medication(s) using the HealthDesk Rx role on a client computer. This process generates a printed copy of the new prescription(s). A one-time code is printed on the prescription; this one time code is computer-generated, and is stored on the server computer in a table contained in a database that allows the retrieval of the prescription information based on the one-time code.

6) The patient takes the prescription to a pharmacist who belongs to the Network, who uses the (access-protected) web pages associated with the “Pharmacist” role to retrieve the prescription information from the central server by submitting the corresponding the onetime code that is printed on the prescription, using one or more steps to accomplish the automated transfer of this prescription information from the inventive system to another information technology system belonging to the pharmacist. As an alternative to step 6, above, the patient takes the prescription to a pharmacist who does not yet belong to the Network, who uses the (non-password protected) web pages associated with the “RxCheck” role to verify the authenticity of the information printed on the prescription, but is unable to accomplish the automated transfer of this prescription information from the inventive system to another information management system belonging to the pharmacist. One preferred way to accomplish this is to display, in the context of a web page, an image (e.g., gif file) of the prescription.

7) All of the web pages associated with each of the roles described are access protected, with the exception of the web pages associated with the RxCheck role. Access-protected means, in this context, that access to the relevant web pages is limited by various means including password protection to authenticated users of the system.

All of the web pages are illustrative. A separate application running on the client computer could also be used. However, in a preferred embodiment of the invention, the user interface appears in the context of a browser window (for example, Internet Explorer). This helps signify that the end-user is not required to download a separate application prior to using the system, a specific advantage of this embodiment of the current invention. This also helps represent the ease of maintenance associated with system use on the part of end-users. Nonetheless, a dedicated server system and network may be utilized to practice the invention.

Accordingly, several advantages and objects of the present invention are:

1) Effectively creating an incentive for otherwise unrelated participants in the health care industry to participate in a Network, using a common platform to accomplish the secured transmission of protected health information from one computer application (the inventive system) to another.

2) Effectively creating an incentive for otherwise unrelated participants in the health care industry to participate in a Network, using a common platform to accomplish the secured availability (with or without transmission) of protected health information from one computer application (the inventive system) to a health care worker.

3) Using only a Web-based prescribing system, and an ordinary laser printer, prescription information is created which is amenable to automated transfer from the inventive system to diverse other information systems belonging to pharmacists, health care providers, or other participants in the health care industry.

4) Tamper-evident prescriptions are creating using ordinary paper with no specific tamper-evident features built into it

5) Effectively, secured, automated transmission of protected health information can be accomplished without any foreknowledge on the part of the patient, or health care provider, of the next intended recipient of the information. This overcomes an obstacle associated with some current methods of electronic prescribing, which forces the patient or health care provider to designate the intended recipient pharmacist prior to the creation and/or transmission of the prescription information.

6) Effectively, using one preferred embodiment of the current system, a machine could be created that automatically dispenses medications in response to the submission of a valid one-time code to the central server via an interface incorporated into the machine.

While various embodiments or variations thereof are disclosed, the invention is limited only by the following claims and equivalents thereof.

1. A method for management and distribution of authorized medical prescriptions to preserve patient privacy, to enable authorized access of physicians, patients, pharmacists and authorized entities to patient prescription information, to preclude tampering with said prescription information and to enable hard copy issuance and use of prescription information by entities in the role of prescribing, fulfilling and using prescriptions by means of an electronic information network accessible by unrelated participants by providing incentives to be participants comprising the steps of:
(a) establishing a network having a common platform and a central server;
(b) loading the central server with a first database of general prescription and drug information;
(c) inputting by input means into the network a coded prescription by an authorized prescriber and assigning a unique, one-time code to said coded prescription;
(d) printing a hard copy of the said coded prescription by means of a printer;
(e) authorizing through said server multiple approved drug dispensing entities to receive general access to the network;
(f) uploading by an authorized drug dispensing entity into the network through the server the one-time code of the hard copy prescription by means of a reading device;
(g) enabling the authorized drug entity to have access to the coded prescription information and authorization to fulfill the coded prescription by said server through the network;
(h) retaining the hard copy upon fulfillment by the authorized dispensing entity;
(i) inputting confirmation of fulfillment of the coded prescription by the drug dispensing entity into the network server; and
(j) storage by the network server of the coded prescription transaction.

2. A system for management and distribution of authorized medical prescriptions to preserve patient privacy, to enable authorized access of physicians, patients, pharmacists and authorized entities to patient prescription information to preclude tampering with said prescription information and to enable hard copy issuance and use of prescription information by entities in the role of prescribing, fulfilling and using prescriptions comprising:
(a) a central server and information storage center having a common platform; and
(b) a network for said server, said network including one or more prescription input stations, and one or more prescription fulfillment stations;
said input stations including a code generator for assigning a unique code to each one of multiple prescriptions for a specific patient and a hard copy prescription printer;
said fulfillment stations including a reader and transmitter of a coded prescription to the central server for verification of the prescription, securing authorization for fulfillment and storing confirmation of fulfillment of each prescription sorted and stored uniquely for the specific patient.

3. The system of claim 2 further including a reader for accessing a drug fulfillment record at the input stations and/or fulfillment stations.
